(19) United States
(12) Patent Application Publication
(10) Pub. No.: US 2026/0119020 A1
(43) Pub. Date: Apr. 30, 2026

(54) MULTI-WINDOW DISPLAY METHOD AND ELECTRONIC DEVICE THEREFOR

(71) Applicant: ASUSTEK COMPUTER INC., TAIPEI (TW)

(72) Inventors: Han-Jou CHANG, TAIPEI (TW); Hsin-Yi PU, TAIPEI (TW); Yu-Rou WANG, TAIPEI (TW)

(21) Appl. No.: 18/986,389

(22) Filed: Dec. 18, 2024

(30) Foreign Application Priority Data
Oct. 28, 2024 (TW) 113141054

(51) Int. Cl. G06F 3/04845; G06F 3/04817

(52) U.S. Cl. CPC G06F 3/04845; G06F 3/04817; G06F 2203/04803

(57) ABSTRACT

A multi-window display method applicable to an electronic device is provided. First, a multi-window icon is set in a setting window. The multi-window icon corresponds to at least a first application and a second application. Then, a multi-window interface is generated in response to a first operation corresponding to the multi-window icon. The multi-window interface includes a first window, a second window, and a separation region, the first application is executed in the first window, the second application is executed in the second window, and the separation region is located between the first window and the second window. Then, a floating window interface is generated in response to a second operation corresponding to a frame region of the second window. The floating window interface includes a main window and a floating window. An electronic device for performing the multi-window display method is further provided.

### CROSS-REFERENCE TO RELATED APPLICATION

This application claims the priority benefit of Taiwan Application Serial No. 113141054, filed on Oct. 28, 2024. The entirety of the above-mentioned patent application is hereby incorporated by reference herein and made a part of specification.

### BACKGROUND OF THE INVENTION

### Field of the Invention

The disclosure relates to a display method for an electronic device, and in particular, to a multi-window display method and an electronic device therefor.

### Description of the Related Art

With the development of electronic product technologies, the screen size of handheld electronic devices (such as mobile phones or tablet computers) is increasingly large, and the installed applications are increasingly diverse.

To meet user demands, electronic devices supporting a multi-window mode appear on the market, allowing users to run and display a plurality of applications simultaneously on a single screen.

However, an enabling and switching process of a conventional multi-window mode is excessively complicated, easily leading to a poor user experience.

### BRIEF SUMMARY OF THE INVENTION

The disclosure provides a multi-window display method, applicable to an electronic device. The multi-window display method includes the following steps. First, a multi-window icon is set in a setting window. The multi-window icon corresponds to at least a first application and a second application. Then, a multi-window interface is generated in response to a first operation corresponding to the multi-window icon. The multi-window interface includes a first window, a second window, and a separation region, the first application is executed in the first window, the second application is executed in the second window, and the separation region is located between the first window and the second window. Then, a floating window interface is generated in response to a second operation corresponding to a frame region of the second window. The floating window interface includes a main window and a floating window. The first window is converted into the main window, and the second window is converted into the floating window.

An electronic device is provided, including a setting window generation module, a multi-window icon generation module, a multi-window interface generation module, and a first window conversion module. The setting window generation module is configured to generate a setting window. The multi-window icon generation module is configured to set a multi-window icon in the setting window. The multi-window icon corresponds to at least a first application and a second application. The multi-window interface generation module is configured to generate a multi-window interface in response to a first operation corresponding to the multi-window icon. The multi-window interface includes a first window, a second window, and a separation region. The first application is executed in the first window, the second application is executed in the second window, and the separation region is located between the first window and the second window. The first window conversion module is configured to generate a floating window interface in response to a second operation corresponding to a frame region of the second window. The floating window interface includes a main window and a floating window. The first window is converted into the main window, and the second window is converted into the floating window to float on the main window.

Through the multi-window display method and the electronic device therefor provided in the disclosure, a user enables a multi-window mode or performs switching between the multi-window mode and a floating window mode through a simple gesture operation, which helps alleviate a problem of poor user experience in a conventional multi-window mode.

### BRIEF DESCRIPTION OF THE DRAWINGS

FIG. 1 is a flowchart of a multi-window display method according to an embodiment of the disclosure;

FIG. 2 is a schematic diagram of a multi-window icon according to an embodiment of the disclosure;

FIG. 3 is a schematic diagram of a setting window according to an embodiment of the disclosure;

FIG. 4 is a schematic diagram of a multi-window interface according to an embodiment of the disclosure;

FIG. 5 is a schematic diagram of a floating window interface according to an embodiment of the disclosure;

FIG. 6 is a flowchart of a multi-window display method according to another embodiment of the disclosure; and

FIG. 7 is a schematic block diagram of an electronic device according to an embodiment of the disclosure.

### DETAILED DESCRIPTION OF THE EMBODIMENTS

More detailed descriptions of specific implementations of the disclosure are provided below with reference to the schematic diagrams. The features and advantages of the disclosure are described more clearly according to the following description and claims. It is to be noted that all of the drawings use very simplified forms and imprecise proportions, only being used for assisting in conveniently and clearly explaining the objective of the embodiments of the disclosure.

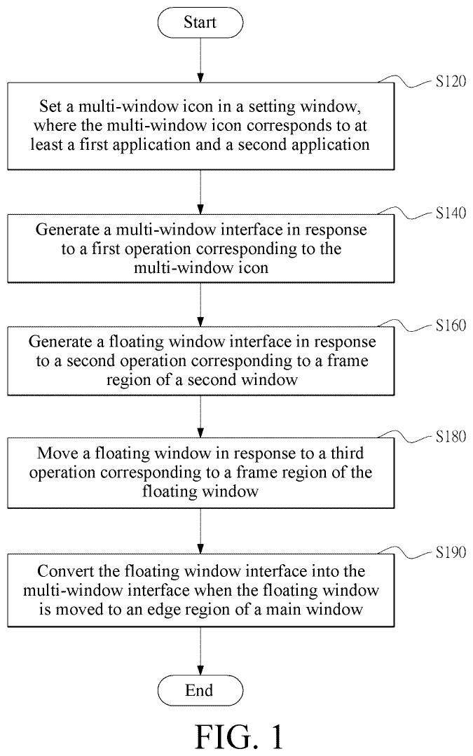

FIG. 1 is a flowchart of a multi-window display method according to an embodiment of the disclosure.

The multi-window display method provided in this embodiment is applicable to an electronic device 200. In an embodiment, the electronic device 200 is a handheld electronic device, such as a tablet computer or a smartphone. The multi-window display method includes the following steps.

First, as described in step S120, a multi-window icon 210 is set in a setting window 220. The multi-window icon 210 corresponds to at least a first application and a second application.

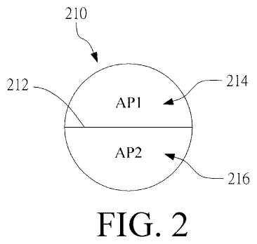

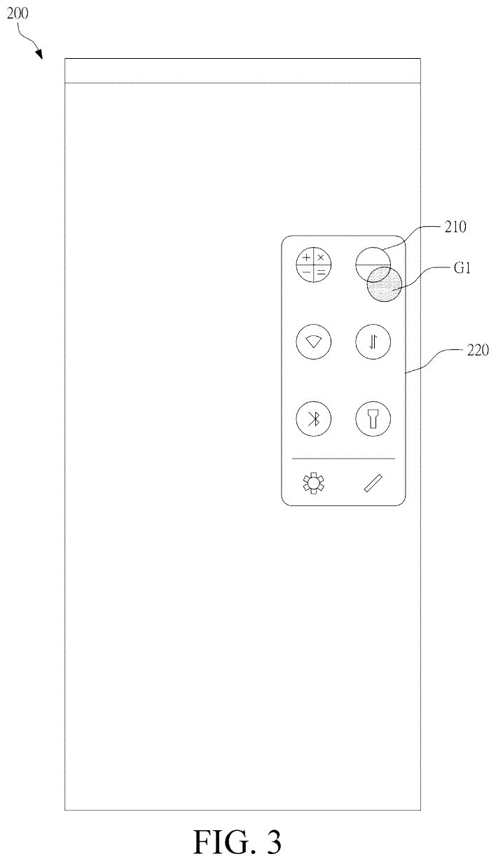

Referring to FIG. 2 and FIG. 3 together, FIG. 2 is a schematic diagram of a multi-window icon 210 according to an embodiment of the disclosure, and FIG. 3 is a schematic diagram of a setting window according to an embodiment of the disclosure. A smartphone is shown in the figure as an example.

As shown in FIG. 2, the multi-window icon 210 is circular, and is divided into an upper half 214 and a lower half 216 through a divider line 212. A graphic or a color presented in the upper half 214 corresponds to the first application, and a graphic or a color presented in the lower half 216 corresponds to the second application.

In other embodiments, the multi-window icon 210 is alternatively presented as a square or another symmetrical shape. In other embodiments, the multi-window icon 210 is divided into a plurality of parts based on demands (that is, corresponding application types), and representative icons or colors of corresponding applications are presented in each part.

In addition, as shown in FIG. 3, in an embodiment, the setting window 220 is a pop-up window on a side of a screen of the electronic device 200 (that is, a window generated from the side of the screen in response to an operation of a user), and the user sets the multi-window icon 210 through the setting window 220. According to different operation interface designs, the setting window 220 is alternatively a pop-up window at the bottom of the screen, or a window presented in response to a specific gesture operation.

Then, as described in step S140, a multi-window interface 240 is generated in response to a first operation G1 corresponding to the multi-window icon 210. For the first operation G1, refer to FIG. 3. In an embodiment, the first operation G1 is a tap operation corresponding to the multi-window icon 210.

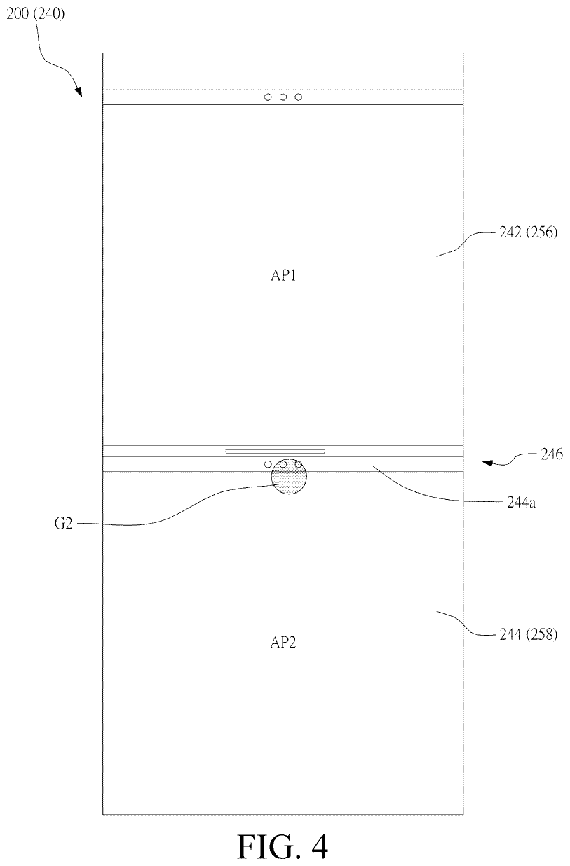

Referring to FIG. 4 together, FIG. 4 is a schematic diagram of a multi-window interface 240 according to an embodiment of the disclosure. As shown in the figure, the multi-window interface 240 includes a first window 242, a second window 244, and a separation region 246, the first application is executed in the first window 242, the second application is executed in the second window 244, and the separation region 246 is located between the first window 242 and the second window 244.

In this embodiment, the first window 242 is an upper window, and the second window 244 is a lower window. The multi-window interface 240 alternatively includes three or more windows. The arrangement of the windows is not limited to vertical arrangement, and sizes of the windows are set according to a preset rule and do not need to be the same.

Then, as described in step S160, a floating window interface 250 is generated in response to a second operation G2 corresponding to a frame region 244a of the second window 244. For the second operation G2, refer to FIG. 4. In an embodiment, the second operation G2 is a touch and hold operation corresponding to the frame region 244a of the second window 244. Further, in an embodiment, the second operation G2 corresponds to an upper side frame of the second window 244. In other embodiments, the frame region 244a is alternatively a lower side frame or a left or right side frame of a floating window 254.

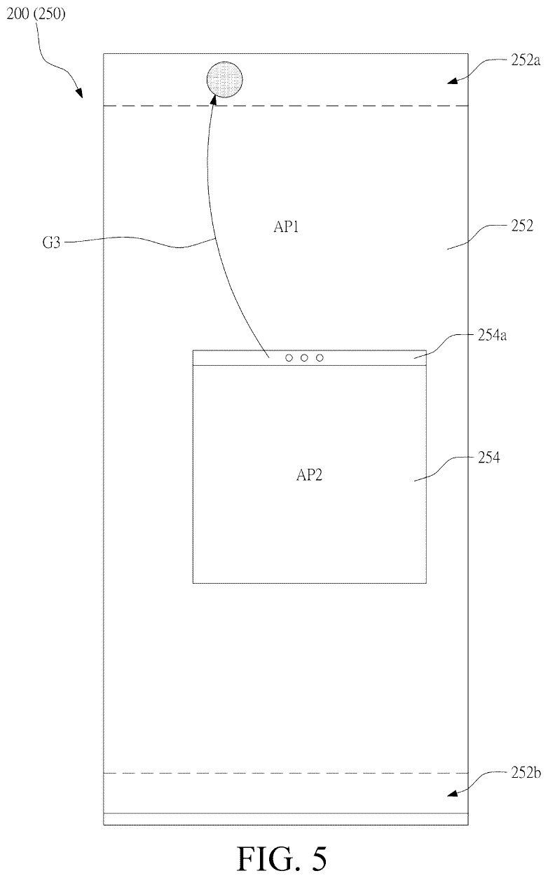

Referring to FIG. 5 together, FIG. 5 is a schematic diagram of a floating window interface 250 according to an embodiment of the disclosure. As shown in the figure, the floating window interface 250 includes a main window 252 and a floating window 254. The first window 242 is converted into the main window 252, and the second window 244 (that is, a window to which the second operation G2 is directed) is converted into the floating window 254 to float on the main window 252.

The second operation G2 in the foregoing embodiment is performed on the frame region 244a of the second window 244. In an embodiment, when the second operation G2 is performed on a frame region of the first window 242, the second window 244 is converted into the main window 252, and the first window 242 is converted into the floating window 254 to float on the main window 252.

Next, as described in step S180, the floating window 254 is moved in response to a third operation G3 corresponding to a frame region 254a of the floating window 254. Then, as described in step S190, the floating window interface 250 is converted into the multi-window interface 240 when the floating window 254 is moved to an edge region 252a or 252b of the main window 252. In an embodiment, the frame region 254a is an upper side frame of the floating window 254. In other embodiments, the frame region 254a is a lower side frame or a left or right side frame of the floating window 254.

In an embodiment, the edge region 252a or 252b is located at an upper edge or a lower edge of the main window 252. For the third operation G3, refer to FIG. 5. In an embodiment, the third operation G3 is a drag operation corresponding to the floating window 254.

Specifically, when a current display interface is the floating window interface 250, when a touch position falls within the frame region 254a of the floating window 254 and a continuous touch is detected, it is determined that the third operation G3 is performed, and the floating window 254 is moved based on a touch track. When the touch track (coordinate) moves to the edge region 252a or 252b of the main window 252, the floating window interface 250 is converted into the multi-window interface 240.

Referring to FIG. 4 together, when the third operation G3 moves the floating window 254 to the edge region 252a located at the upper edge of the main window 252, the floating window 254 is converted into an upper window 256, and the main window 252 is converted into a lower window 258. When the third operation G3 moves the floating window 254 to the edge region 252b located at the lower edge of the main window 252, the floating window 254 is converted into a lower window 258, and the main window 252 is converted into an upper window 256.

Further, in an embodiment, as shown in the figure, when the electronic device 200 is operated upright, the edge regions 252a and 252b are set at an upper edge and a lower edge of the main window 252. When the electronic device 200 is operated transversely, the edge regions 252a and 252b are alternatively set at a left edge and a right edge of the main window 252. Further, an upright operation mode and a transverse operation mode are detected by using a gyroscope or an accelerometer.

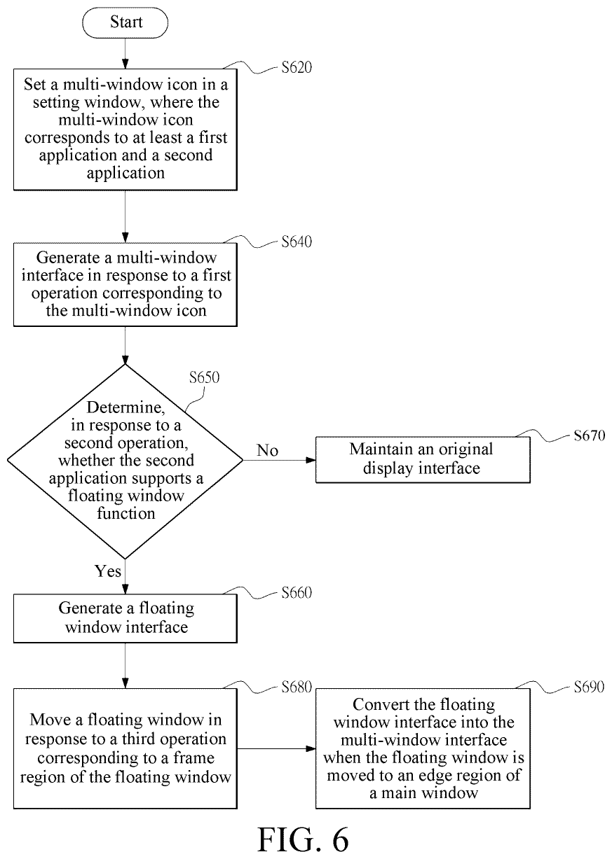

FIG. 6 is a flowchart of a multi-window display method according to another embodiment of the disclosure.

The multi-window display method provided in this embodiment is applicable to an electronic device 200. In an embodiment, the electronic device 200 is a handheld electronic device, such as a tablet computer or a smartphone. The multi-window display method includes the following steps.

First, as described in step S620, a multi-window icon 210 is set in a setting window 220. The multi-window icon 210 corresponds to at least a first application and a second application.

Then, as described in step S640, a multi-window interface 240 is generated in response to a first operation G1 corresponding to the multi-window icon 210. The multi-window interface 240 includes a first window 242, a second window 244, and a separation region 246, the first application is executed in the first window 242, the second application is executed in the second window 244, and the separation region 246 is located between the first window 242 and the second window 244. In an embodiment, the first operation G1 is a tap operation.

Then, as described in step S650, whether the second application supports a floating window function is determined in response to a second operation G2 corresponding to a frame region 244a of the second window 244.

When the second application supports the floating window function, the process goes to step S660 to generate a floating window interface 250. The floating window interface 250 includes a main window 252 and a floating window 254. The first window 242 is converted into the main window 252, and the second window 244 is converted into the floating window 254 to float on the main window 252. In an embodiment, the second operation G2 is a touch and hold operation.

When the second application does not support the floating window function, the process goes to step S670 to maintain an original display interface.

Based on step S660, next, as described in step S680, the floating window 254 is moved in response to a third operation G3 corresponding to a frame region 254a of the floating window 254. Then, as described in step S690, the floating window interface 250 is converted into the multi-window interface 240 when the floating window 254 is moved to an edge region 252a or 252b of the main window 252. In an embodiment, the third operation G3 is a drag operation.

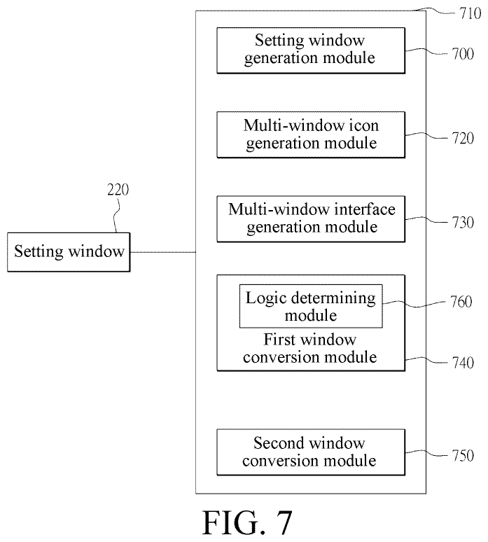

FIG. 7 is a schematic block diagram of an electronic device 700 according to an embodiment of the disclosure. The electronic device 700 is a handheld electronic device.

As shown in the figure, the electronic device 700 includes a setting window generation module 710, a multi-window icon generation module 720, a multi-window interface generation module 730, and a first window conversion module 740.

The setting window generation module 710 is configured to generate a setting window 220 shown in FIG. 3 on a screen of the electronic device 700. The multi-window icon generation module 720 is configured to set a multi-window icon 210 at the setting window 220. The multi-window icon 210 corresponds to at least a first application AP1 and a second application AP2. In other words, the first application AP1 and the second application AP2 are simultaneously enabled by triggering the multi-window icon 210.

Referring to FIG. 3 and FIG. 4 together, the multi-window interface generation module 730 is configured to generate a multi-window interface 240 in response to a first operation G1 corresponding to the multi-window icon 210, to enter a multi-window mode. The multi-window interface 240 includes a first window 242, a second window 244, and a separation region 246. The first application AP1 is executed in the first window 242, the second application AP2 is executed in the second window 244, and the separation region 246 is located between the first window 242 and the second window 244.

Referring to FIG. 4 and FIG. 5 together, the first window conversion module 740 is configured to generate a floating window interface 250 in response to a second operation G2 corresponding to a frame region 244a of the second window 244, to enter a floating window mode. The floating window interface 250 includes a main window 252 and a floating window 254. The first window 242 (that is, a window not tapped by the second operation G2) is converted into the main window 252, and the second window 244 (that is, a window tapped by the second operation G2) is converted into the floating window 254 to float on the main window 252.

In an embodiment, referring to FIG. 4 and FIG. 5 together, the electronic device 700 further includes a second window conversion module 750, configured to move the floating window 254 in response to a third operation G3 corresponding to a frame region 254a of the floating window 254, and convert the floating window interface 250 into the multi-window interface 240 when the floating window 254 is moved to an edge region 252a or 252b of the main window 252, to enter a multi-window mode.

In an embodiment, the electronic device 700 further includes a logic determining module 760, configured to determine, in response to the second operation G2, whether the second application AP2 (that is, an application corresponding to the window to which the second operation G2 is directed) supports a floating window function.

Through the multi-window display method and the electronic devices 200 and 700 therefor provided in the disclosure, the user enables a multi-window mode or performs switching between the multi-window mode and the floating window mode through a simple gesture operation (that is, the first operation G1, the second operation G2, and the third operation G3), which helps alleviate a problem of poor user experience in a conventional multi-window mode.

The above is merely exemplary embodiments of the disclosure, and does not constitute any limitation on the disclosure. Any form of equivalent replacements or modifications to the technical means and technical content disclosed in the disclosure made by a person skilled in the art without departing from the scope of the technical means of the disclosure still fall within the content of the technical means of the disclosure and the protection scope of the disclosure.

What is claimed is:

1. A multi-window display method, applicable to an electronic device, wherein the electronic device comprises a setting window, a first application, and a second application, and the multi-window display method comprises:
setting a multi-window icon in the setting window, wherein the multi-window icon corresponds to at least the first application and the second application;
generating a multi-window interface in response to a first operation corresponding to the multi-window icon, wherein the multi-window interface comprises a first window, a second window, and a separation region, the first application is executed in the first window, the second application is executed in the second window, and the separation region is located between the first window and the second window; and
generating a floating window interface in response to a second operation corresponding to a frame region of the second window, wherein the floating window interface comprises a main window and a floating window, the first window is converted into the main window, and the second window is converted into the floating window to float on the main window.

2. The multi-window display method according to claim 1, further comprising: moving the floating window in response to a third operation corresponding to a frame region of the floating window, and converting the floating window interface into the multi-window interface when the floating window is moved to an edge region of the main window.

3. The multi-window display method according to claim 2, wherein the edge region is located at an upper edge of the main window, and when the third operation moves the floating window to the edge region, the floating window is converted into an upper window, and the main window is converted into a lower window.

4. The multi-window display method according to claim 2, wherein the edge region is located at a lower edge of the main window, and when the third operation moves the floating window to the edge region, the floating window is converted into a lower window, and the main window is converted into an upper window.

5. The multi-window display method according to claim 1, wherein the first operation is a tap operation.

6. The multi-window display method according to claim 1, wherein the second operation is a touch and hold operation.

7. The multi-window display method according to claim 2, wherein the third operation is a drag operation.

8. The multi-window display method according to claim 1, wherein the setting window is a pop-up window on a side of a screen of the electronic device.

9. The multi-window display method according to claim 1, further comprising: determining, in response to the second operation, whether the second application supports a floating window function, and generating the floating window interface when the second application supports the floating window function.

10. An electronic device, comprising:
a setting window generation module, configured to generate a setting window;
a multi-window icon generation module, configured to set a multi-window icon in the setting window, wherein the multi-window icon corresponds to at least a first application and a second application;
a multi-window interface generation module, configured to generate a multi-window interface in response to a first operation corresponding to the multi-window icon, wherein the multi-window interface comprises a first window, a second window, and a separation region, the first application is executed in the first window, the second application is executed in the second window, and the separation region is located between the first window and the second window; and
a first window conversion module, configured to generate a floating window interface in response to a second operation corresponding to a frame region of the second window, wherein the floating window interface comprises a main window and a floating window, the first window is converted into the main window, and the second window is converted into the floating window to float on the main window.

11. The electronic device according to claim 10, further comprising a second window conversion module, configured to move the floating window in response to a third operation corresponding to a frame region of the floating window, and convert the floating window interface into the multi-window interface when the floating window is moved to an edge region of the main window.

12. The electronic device according to claim 10, further comprising a logic determining module, configured to determine, in response to the second operation, whether the second application supports a floating window function.
